(19) United States
(12) Patent Application Publication
(10) Pub. No.: US 2012/0274584 A1
(43) Pub. Date: Nov. 1, 2012

(54) COMMUNICATIONS SYSTEM

(76) Inventor: Victor Schweikart, Melbourne (AU)

(21) Appl. No.: 13/381,764

(22) PCT Filed: Jul. 2, 2010
(86) PCT No.: PCT/AU2010/000851

§ 371 Date: Jul. 24, 2012

(30) Foreign Application Priority Data
Jul. 2, 2009 (AU) 2009903095

(51) Int. Cl. G06F 3/041

(52) U.S. Cl. 345/173

(57) ABSTRACT

A communications device (12) for facilitating communications between two remote locations, in particular for mine planning purposes, comprising a touch screen (24), an image display device (22) arranged to display an image, such that the image and the touch screen are in register with each other, and a network interface (40) arranged to facilitate communications between the device (12) and another remotely disposed device. The device (12) is arranged during use to send data indicative of a tactile input detected by the touch screen (24) to another remotely disposed device (12) through the network interface (40), to receive data indicative of a tactile input detected by a touch screen (24) of another remotely disposed device (14) through the network interface (40), and to incorporate into the displayed image a representation of a tactile input corresponding to tactile input data received from the other remotely disposed mine planning device (14).

### FIELD OF THE INVENTION

The present invention relates to a communications system, and in particular to a mine planning device, system and method for facilitating mine planning communications between two locations.

### BACKGROUND OF THE INVENTION

It is known that in order to maintain efficiency at a mine operation such as a mine site, it is necessary for mine planners to carefully plan mine operations in advance, in particular which parts of the site will be mined next, where mine equipment should be located, and the transportation routes which will be used to cart ore through the mine to stock piles and processing plant. This has hitherto predominantly been carried out by mine planners located at the mine site with input from remotely located mine planners as required.

However, with the current arrangement, it is difficult for local and remotely disposed mine planners to effectively communicate with each other.

### SUMMARY OF THE INVENTION

In accordance with a first aspect of the present invention, there is provided a mine planning device, the device comprising:
a touch screen;
an image display device arranged to display a mine planning image relevant to mine planning such that the mine planning image and the touch screen are in register with each other; and
a network interface arranged to facilitate communications between the mine planning device and another mine planning device disposed at a remote location;
the touch screen being arranged to detect tactile inputs;
the touch screen and the image display device being operatively associated with each other such that a representation of a tactile input detected by the touch screen is incorporated into the displayed mine planning image; and
the communications device being arranged during use:
   to send data indicative of a tactile input detected by the touch screen to another remotely disposed mine planning device through the network interface;
   to receive data indicative of a tactile input detected by a touch screen of another remotely disposed mine planning device through the network interface; and
   to incorporate into the displayed mine planning image a representation of a tactile input corresponding to tactile input data received from another remotely disposed mine planning device.

In one embodiment, the touch screen is transparent.

In one embodiment, the image display device is a display screen and the touch screen is disposed over the display screen.

In an alternative embodiment, the image display device comprises a projector arranged to project an image such that the image is in registration with the touch screen. The image may be projected onto the touch screen.

In one embodiment, the display and the touch screen are disposed in a generally horizontal orientation, and may comprise or be incorporated into a table.

In one embodiment, the touch screen is arranged to detect a tactile input only when the touch screen is touched by a specifically configured device.

In one embodiment, the colour of the representation of the tactile input is dependent on the specifically configured device.

In addition or alternatively, the colour of the representation of the tactile input is dependent on the mine planning device such that different mine planning devices have different associated colours.

The device may be arranged to detect when a specifically configured device has been selected and to activate detection of interaction between the touch screen and the specifically configured device when selection is detected. The device may be arranged to respond differently to tactile inputs when selection of a specifically configured device is not detected.

In one embodiment, the device is arranged so as to communicate data indicative of a mine planning image to another remotely disposed mine planning device such that the mine planning image is synchronisable with and thereby also displayable on the other remotely disposed mine planning device.

The data indicative of the mine planning image may be stored locally at the mine planning device or may be derived from a computer program, such as a CAD program.

In one embodiment, the mine planning device is arranged to receive data indicative of audio, video and/or images from an external source and to communicate the received data to a another remotely disposed mine planning device.

The network interface may be arranged to facilitate communications with another communications device through a wide area network.

In accordance with a second aspect of the present invention, there is provided a collaboration room comprising a mine planning device according to the first aspect of the present invention, and a conferencing system arranged to communicate audio information between users of the mine planning device positioned within the collaboration room and users of another mine planning device disposed at a remote location.

The conferencing system may be arranged to communicate audio/visual information between users of the mine planning device positioned within the collaboration room and users of another mine planning device disposed at a remote location.

In one embodiment, the mine planning device has an associated secondary display, which may be at least 101 cm.

In one embodiment, the collaboration room is arranged so as to show on the secondary display images and/or video associated with the video conferencing system.

In one embodiment, the same information as is displayed on the display of a mine planning device is shown on the secondary display.

In one embodiment, images received from one or more still and/or video cameras disposed at one or more mine operations are shown on the secondary display.

In one embodiment, the collaboration room comprises a control device arranged to facilitate control of operations in the collaboration room by a user.

The control device may be arranged to facilitate selection of images and/or video to be displayed on the secondary display from a plurality of image and/or video sources.

In accordance with a third aspect of the present invention, there is provided a mine planning system for facilitating mine planning communications between a first location and a second location remote from the first location, the mine planning system comprising at least two mine planning devices according to the first aspect of the present invention;
a first mine planning device disposed at the first location, the first mine planning device comprising a first display and a first touch screen;
a second mine planning device device disposed at the second location, the second mine planning device comprising a second display and a second touch screen; and
a communications network arranged to facilitate communications between the first and second mine planning devices;
the system being arranged to communicate data indicative of tactile inputs detected by the first and second touch screens between the first and second mine planning devices such that representations of tactile inputs detected and incorporated into one of the first and second images are synchronised with and thereby also incorporated into the other of the first and second images.

In accordance with a fourth aspect of the present invention, there is provided a method of mine planning, the method comprising:
providing a first mine planning device disposed at a first location, the first mine planning device comprising a first touch screen and a first image display device arranged to display an image such that the image and the first touch screen are in register with each other, the first touch screen being arranged to detect tactile inputs; and
providing a second mine planning device disposed at a second location remote from the first location, the second mine planning device comprising a second touch screen and a second image display device arranged to display an image such that the image and the second touch screen are in register with each other, the second touch screen being arranged to detect tactile inputs;
showing on the first and second mine planning devices a mine planning image relevant to mine planning;
showing on the mine planning image displayed on the first mine planning device a representation of a tactile input detected by the first touch screen;
showing on the mine planning image displayed on the second mine planning device a representation of a tactile input detected by the second touch screen;
communicating data indicative of tactile inputs detected by the first and second touch screens between the first and second mine planning devices such that tactile inputs detected and incorporated into one of the first and second mine planning images are synchronized with and thereby also incorporated into the other of the first and second mine planning images.

In accordance with a fifth aspect of the present invention, there is provided a collaboration system for facilitating collaboration between people disposed remotely from each other, the collaboration system comprising:
a first communications device disposed at a first location, the first communications device comprising a first touch screen disposed in a generally horizontal orientation and a first image display device arranged to display an image such that the image and the touch screen are in register with each other, the size of the first touch screen being at least 101 cm, and the first touch screen and the first image display device being operatively associated with each other such that a representation of a tactile input detected by the first touch screen is incorporated into the image displayed by the first image display device;
a second communications device disposed at a second location remote from the first location, the second communications device comprising a second touch screen disposed in a generally horizontal orientation and a second image display device arranged to display an image such that the image and the second touch screen are in register with each other, the size of the second touch screen being at least 101 cm, and the second touch screen and the second image display device being operatively associated with each other such that a representation of a tactile input detected by the second touch screen is incorporated into the image displayed by the second image display device; and
a communications network arranged to facilitate communications between the first and second communications devices;
the system being arranged to communicate data indicative of tactile inputs detected by the first and second touch screens between the first and second communications devices such that representations of tactile inputs detected and incorporated into one of the first and second images are synchronised with and thereby also incorporated into the other of the first and second images.

### BRIEF DESCRIPTION OF THE DRAWINGS

The present invention will now be described by way of example only, with reference to the accompanying drawings, in which:

FIG. 1 is a schematic diagram of a communications system in accordance with an embodiment of the present invention;

FIG. 2 is a diagrammatic exploded perspective view of a communications device according to an embodiment of the present invention;

FIG. 3 is a schematic block diagram of operative components of the communications device shown in FIGS. 1 and 2;

FIG. 4 is a diagrammatic perspective view of a collaboration room including a communications device according to the embodiment shown in FIGS. 1 to 3; and

FIG. 5 is a diagrammatic plan view of a display of a communications device according to an embodiment of the present invention with the display showing a map of a mine operation.

### DESCRIPTION OF AN EMBODIMENT OF THE INVENTION

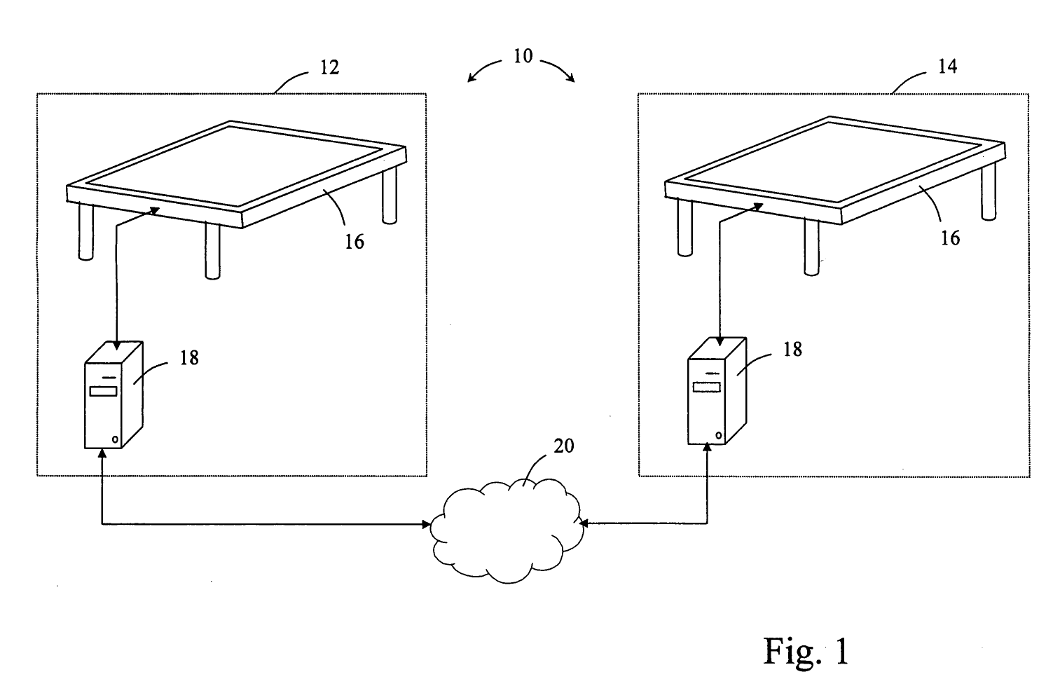

Referring to the drawings, in FIG. 1 there is shown a communications system 10, in this example in the form of a mine planning system for facilitating communications between a mine operation and a location remote from the mine operation, for example a metropolitan location.

In this example, a mine operation may be a mine site, a port facility, a rail facility, or any facility associated with extracting, handling, processing or transporting bulk commodities in a mining environment.

Typically, a mine site produces a single bulk commodity, such as iron ore, coal or bauxite, and may be serviced by a rail network comprising one or more rail lines that transport the bulk commodities produced at the mine site to a port facility, or other facility incorporating a stockyard for storage and/or processing of the bulk commodity.

In operation, mine sites typically have daily, weekly, monthly and annual schedules for mining of ore and waste. Where multiple mine sites are serviced by a common rail network, transportation of ore from each of the minesites to the port facility is scheduled according to the daily, weekly and monthly schedules of the various minesites. A stockyard at the port facility receives ore from the rail to network at a train loadout facility which places the ore onto conveyors that in turn route the ore to a designated stockpile. The placement of ore onto the stockpiles may be scheduled so that the ore from the various minesites is blended to produce a uniform product prior to loading of the ships at the port facility. Alternately, the stockpiles may be blended into various qualities of ores, such as high grade ore and low grade ore or ore with specific characteristics. Alternately, ore may be blended at each minesite prior to railing so that each minesite produces a specified average grade of ore that is then railed to the port facility. Under these conditions the ore is routed from the train loadout facility to a designated stockpile without further blending.

In order to maintain efficiency at each mine operation and maintain desired production levels, it is necessary for mine planners to determine in advance how a mine will be developed and how associated processes, operations, schedules, and so on, are to be modified and/or developed as production proceeds. For example, as production proceeds at a mine site, mine planners are required to determine which parts of the site will be mined next, where mine equipment should be located, and the routes which will be used, for example for trucks transferring the mined bulk commodity from the mined area to mine equipment such as crushing and/or processing equipment. Traditionally, this has predominantly been carried out by mine planners located at the mine site with input from remotely located mine planners by videoconference or site visits as required.

The communications system 10 includes a first communications device 12, in this example in the from of a first mine planning device located at a mine operation, and a second communications device 14, in this example in the from of a second mine planning device, disposed at a remote location, in this example disposed at a metropolitan location.

Each of the first and second communications devices 12, 14 includes an interactive screen 16, in this example incorporated into a table such that the interactive screen 16 is disposed horizontally during use. Each interactive screen 16 is interfaced to a computing device 18 which receives inputs from the interactive screen 16 and controls outputs to the interactive screen 16 for display on the screen. The interactive screen may be sufficiently large such that a group of people disposed around the interactive screen 16 can easily view information displayed on the screen. For example, the interactive screen may be at least 101 cm and in one embodiment at least 132 cm between oppositely disposed corners.

The respective computing devices 18 of the first and second communications devices 12, 14 are configured so as to be network enabled and arranged such that when the computing devices are connected to a wide area network, such as the Internet 20, a communications link can be established between the computing devices 18. The communications link may be of network type such that the computing devices 18 together form a private wide area network (WAN).

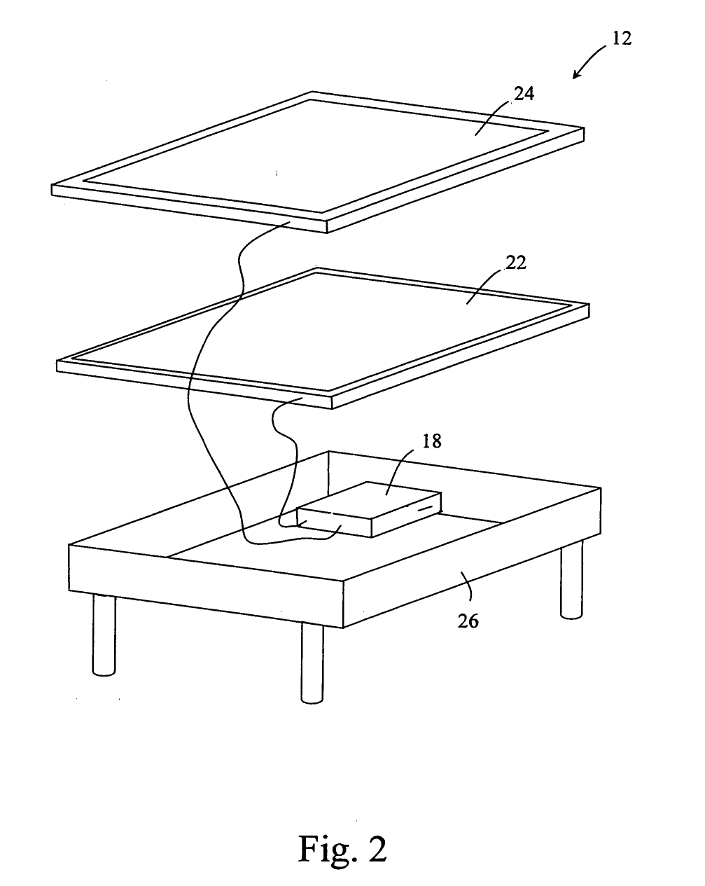

As shown more particularly in FIG. 2, in this example each communications device 12, 14 comprises an image display device in the form of a display screen 22, and a touch screen 24 of similar size to the display screen 22 and disposed during use over the display screen 22. The touch screen 24 is substantially transparent such that the display screen 22 is visible through the touch screen 24.

Each communications device 12, 14 also includes a frame 26 which houses the computing device 18 and which receives the display screen 22 and the touch screen 24. The frame 26, the display screen 22 and the touch screen 24 are configured so as to define a table.

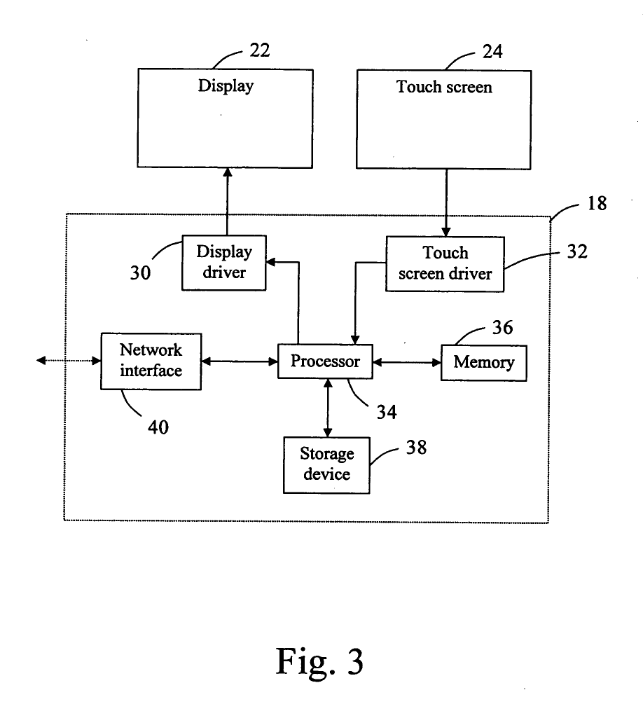

Functional components of the communications device 12, 14 are shown in FIG. 3. As shown, the computing device 18 in this example comprises a display driver 30 arranged to interface with the display screen 22 and control operation of the display screen 22, a touch screen driver 32 arranged to interface with the touch screen 24 and control operation of the touch screen 24, and a processor 34 which controls and coordinates operation of the communications device 12, 14.

The communications device 12, 14 in this example also includes a memory 36, for example in the form of RAM, for temporarily holding programs and data used by the processor 34 during use, a storage device 38 arranged to store programs and data for use by the processor 34, and a network interface 40 which facilitates connection of the communications device 12 to a wide area network 20 and thereby to another similarly configured communications device.

In this example, the computing device 18 is implemented using a personal computer provided with appropriate display and touch screen drivers 30, 32 implemented in hardware and/or software, although it will be understood that any suitable computing device is envisaged.

Each computing device 18 is arranged such that when a tactile input is detected at the respective touch screen 24, a representation of the tactile input is shown on the respective display screen 22. In one example, each touch screen 24 is arranged to detect any tactile input received using a pen type device, a finger or a tactile input received in any other way. In other arrangements, each touch screen 24 is arranged only to detect tactile inputs made using a specially configured pen type device.

In one embodiment, one or more of the communications devices may be provided with a plurality of pen type devices, with each pen type device being associated with a different colour and/or writing style such that when the pen is used to touch the touch screen a representation having the associated colour or writing style is incorporated into the displayed image.

In one embodiment, the system is arranged so as to allocate a different colour to each pen associated with the communication system 10 such that each participant in a collaboration meeting facilitated by the communications system 10 is associated with a different colour.

The system may be arranged to detect when a pen has been selected, for example by detecting that the pen has been removed from a tray provided on the communications device, and to activate the communications device to detect interaction with the pen type device when selection of a pen is detected. When selection of a pen is not detected, the communications device may be arranged to respond differently to tactile inputs, for example to facilitate movement of displayed items by a user, scrolling of displayed items, and so on.

Each computing device 18 is also arranged such that when a tactile input is detected at a first communications device 12, data indicative of the tactile input is forwarded through the network interface 40 to a second communications device 14, which may be of the same or different configuration as the first communications device, connected to the first communications device through the wide area network 20. This may be enabled using a suitable program stored in the storage device 38 and used by the processor 34. On receipt of the data indicative of the tactile input, the second communications device 14 incorporates a representation of the tactile input into the image shown on the display screen 22 of the second communications device 14.

In this way, it will be understood that tactile inputs received at one of the first and second communications devices 12, 14 are synchronized and incorporated into the images shown on both communications devices thereby enabling users disposed both at the mine operation and at the remote location to interact substantially in real time with the communications devices as if they were disposed at the same location.

In one arrangement, a communications device 12, 14 is also arranged to forward data indicative of screen representations to another connected communications device so that both communications devices display the same screen information and tactile information. Alternatively, each communications device 12, 14 may be arranged so as to show the same background image data information on the respective displays 22, for example retrieved from a respective local storage device 38 or generated by a program such as a CAD program, with only data indicative of tactile inputs being communicated between the communications devices 12, 14.

In an alternative embodiment, the communications device comprises a touch screen and an image display device in the form of a projector arranged to project an image onto the touch screen such that the projected image is in register with the touch screen.

The communications device 12 may also be arranged to receive inputs from other video sources such as from other computing devices so that the video may be shown on the display screen 22 or projected onto the touch screen by the projector and communicated to other communications devices.

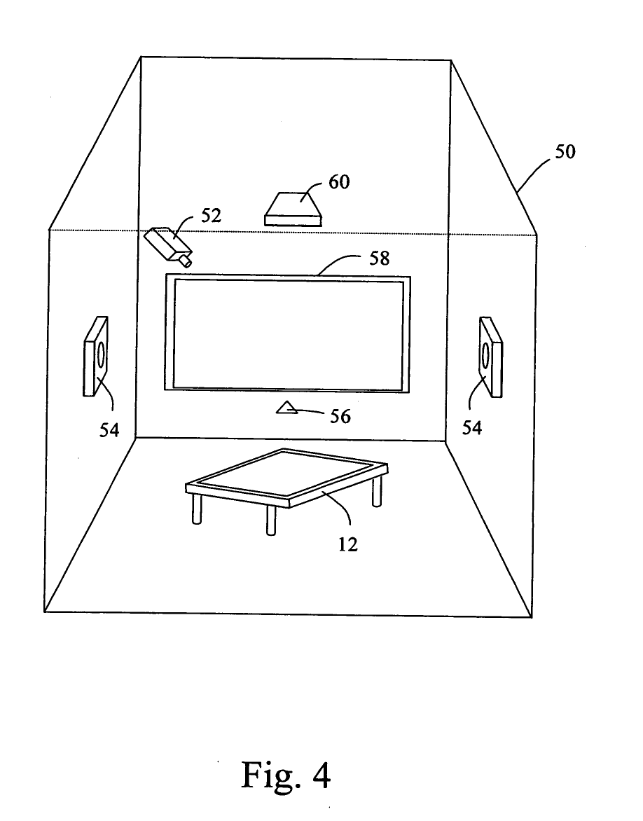

Referring to FIG. 4, a collaboration room 50 is represented, the collaboration room 50 including a communications device 12 of the type shown in FIGS. 1 to 3, speakers 54, a microphone 56, a secondary display 58 and a projector 60.

The collaboration room 50 may be arranged to facilitate audio conferencing, for example using dedicated audioconferencing devices, or using VOIP through the communications devices.

In this example, the collaboration room 50 is configured such that the camera 52 and the microphone 56 capture audio and video information from the room 50 and transfer the information according to conventional video conferencing techniques to another similarly equipped remotely disposed collaboration room 50 for display on another secondary display 58 and audio reproduction using other speakers 54.

In this example, the secondary display 58 is implemented using a projector 60, although it will be understood that any suitable arrangement for displaying images and/or video is envisaged.

The secondary display 58 may also be arranged to display a representation of the display screen 22 of the communications device 12, to display a screen representation derived from a computing device, to display images received from one or more still and/or video cameras disposed at one or more mine operations, and/or to display images and/or video derived from any other source. In one embodiment, a switching device may be provided for receiving inputs from multiple image and/or video sources and facilitating selection either manually or electronically of an image and/or video output to be sent to the secondary display 58.

The secondary display 58 may also be arranged to selectively display video captured by the camera 52 in the room 50 and/or video captured by a camera in another remotely located room.

In one embodiment, the secondary display 58 may be at least 91 cm, preferably at least 101 cm, so that a plurality of people are able to view images shown on the secondary display 58 without difficulty.

In addition, one or more additional screens (not shown) may be provided for displaying a representation of the display screen 22 or displaying other images and/or video.

In addition to the microphone 56, further microphone devices may be provided, for example disposed on the communications device 12, extending downwardly from a ceiling of the room 50, and so on, so that audio is captured efficiently from people in the room, and in particular from users of the communications device 12.

In order to facilitate efficient control of operations in the collaboration room 50, a control device, which may be a remote control device, may be provided. In one embodiment, the control device is arranged to facilitate selection of the images and/or video to be displayed on the secondary display 58, to instigate a videoconference session, to join a videoconference session, to control lighting in the room 50, to control the volume of audio produced by the speakers 54, and so on.

During use, the communications system 10 may be used to facilitate communications between mining personnel disposed at a mine operation and disposed remotely, for example at a metropolitan location.

In particular, the communications system 10 may be used to facilitate mine planning whereby mine personnel disposed at the mine operation and at the remote location together formulate strategies for future development of a mine operation, such as future areas to be mined, development and modification of procedures, operations and strategies, and so on.

This is achieved by presenting an image relevant to mine planning to users at both local and remote locations, and enabling the users to add indicia to the displayed image both locally and remotely.

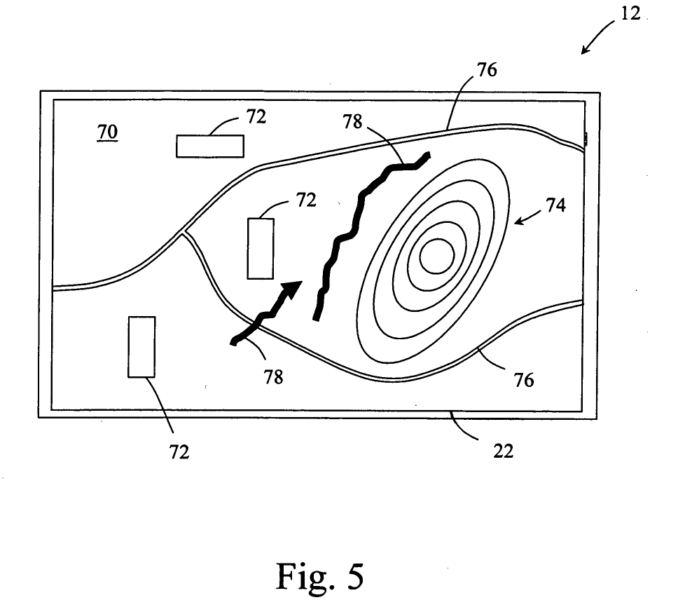

In the present example shown in FIG. 5, a mine site map 70 is shown on the display screen 22 of a first communications device, the mine site map 70 including representations of a plurality of mine facilities 72, an open pit mine 74 and truck routes 76. Using such a communications device 12, 14, an operator is able to add markings 78 to the map 70 by touching the touch screen 24. The tactile inputs received by a first communications device 12 and represented on a first display screen 22 are detected by the first communications device 12 and data indicative of the tactile inputs are forwarded to a second communications device 14 and replicated on a second display screen 22 of the second communications device 14.

It will be understood that in addition to adding markings to the displayed image in response to tactile inputs, the communications device may also be arranged to remove markings from the displayed image, for example using a specifically configured pen type device, or in response to tactile inputs using a finger after an appropriate setting has been activated on the communications device. The markings may also take the form of highlighting of existing displayed items.

It will be appreciated that using the communications is devices 12, 14 mine planners disposed remotely from each other are able to collaborate on mine planning tasks as if they were in the same room.

While the above embodiments are described in relation to a communication system including 2 similar communications devices, it will be understood that other arrangements are possible. For example, the communication system may include more than 2 communications devices, and communications devices of different type may be used, such as of smart board type, of a type according to the above embodiment shown in FIGS. 1 to 3, or of a type including a touch screen and a projector arranged to project an image in registration with the touch screen.

Modifications and variations as would be apparent to a skilled addressee are deemed to be within the scope of the present invention.

1-62. (canceled)

63. A mine planning device, the device comprising:
a touch screen;
an image display device arranged to display a mine planning image relevant to mine planning such that the mine planning image and the touch screen are in register with each other; and
a network interface arranged to facilitate communications between the mine planning device and another mine planning device disposed at a remote location;
the touch screen being arranged to detect tactile inputs;
the touch screen and the image display device being operatively associated with each other such that a representation of a tactile input detected by the touch screen is incorporated into the displayed mine planning image; and
the communications device being arranged during use:
to send data indicative of a tactile input detected by the touch screen to another remotely disposed mine planning device through the network interface;
to receive data indicative of a tactile input detected by a touch screen of another remotely disposed mine planning device through the network interface; and
to incorporate into the displayed mine planning image a representation of a tactile input corresponding to tactile input data received from another remotely disposed mine planning device.

64. The mine planning device as claimed in claim 63, wherein the image display device is a display screen and the touch screen is disposed over the display screen.

65. The mine planning device as claimed in claim 63, wherein the image display device comprises a projector arranged to project an image such that the image is in registration with the touch screen.

66. The mine planning device as claimed in claim 63, wherein the touch screen is arranged to detect a tactile input only when the touch screen is touched by a specifically configured device.

67. The mine planning device as claimed in claim 66, wherein the color of the representation of the tactile input is dependent on the specifically configured device.

68. The mine planning device as claimed in claim 66, wherein the color of the representation of the tactile input is dependent on the mine planning device such that different mine planning devices have different associated colors.

69. The mine planning device as claimed in claim 63, wherein the device is arranged so as to communicate data indicative of a mine planning image to another remotely disposed mine planning device such that the mine planning image is synchronizable with and thereby also displayable on the other remotely disposed mine planning device.

70. The mine planning device as claimed in claim 63, wherein the mine planning device is arranged to receive data indicative of audio, video and/or images from an external source and to communicate the received data to another remotely disposed mine planning device.

71. A collaboration room comprising a mine planning device according to claim 63, and a conferencing system arranged to communicate audio information between users of the mine planning device positioned within the collaboration room and users of another mine planning device disposed at a remote location.

72. The collaboration room as claimed in claim 71, wherein the mine planning device has an associated secondary display.

73. The collaboration room as claimed in claim 72, wherein the collaboration room is arranged so as to show on the secondary display images and/or video associated with the video conferencing system.

74. A mine planning system for facilitating mine planning communications between a first location and a second location remote from the first location, the mine planning system comprising at least two mine planning devices as claimed in claim 63;
a first mine planning device disposed at the first location, the first mine planning device comprising a first display and a first touch screen;
a second mine planning device disposed at the second location, the second mine planning device comprising a second display and a second touch screen; and
a communications network arranged to facilitate communications between the first and second mine planning devices;
the system being arranged to communicate data indicative of tactile inputs detected by the first and second touch screens between the first and second mine planning devices such that representations of tactile inputs detected and incorporated into one of the first and second images are synchronized with and thereby also incorporated into the other of the first and second images.

75. A method of mine planning, the method comprising:
providing a first mine planning device disposed at a first location, the first mine planning device comprising a first touch screen and a first image display device arranged to display an image such that the image and the first touch screen are in register with each other, the first touch screen being arranged to detect tactile inputs; and
providing a second mine planning device disposed at a second location remote from the first location, the second mine planning device comprising a second touch screen and a second image display device arranged to display an image such that the image and the second touch screen are in register with each other, the second touch screen being arranged to detect tactile inputs;
showing on the first and second mine planning devices a mine planning image relevant to mine planning;
showing on the mine planning image displayed on the first mine planning device a representation of a tactile input detected by the first touch screen;
showing on the mine planning image displayed on the second mine planning device a representation of a tactile input detected by the second touch screen; and
communicating data indicative of tactile inputs detected by the first and second touch screens between the first and second mine planning devices such that tactile inputs detected and incorporated into one of the first and second mine planning images are synchronized with and thereby also incorporated into the other of the first and second mine planning images.

76. The method as claimed in claim 75, wherein the image display device is a display screen and method comprises disposing the touch screen over the display.

77. The method as claimed in claim 75, comprising providing a projector arranged to project an image such that the image is in registration with the touch screen.

78. The method as claimed in claim 75, comprising detecting a tactile input only when the touch screen is touched by a specifically configured device.

79. The method as claimed in claim 78, wherein the color of the representation of the tactile input is dependent on the specifically configured device.

80. The method as claimed in claim 78, wherein the color of the representation of the tactile input is dependent on the mine planning device such that different mine planning devices have different associated colors.

81. The method as claimed in claim 75, comprising communicating data indicative of a mine planning image to a another remotely disposed mine planning device, and displaying the mine planning image on the other remotely disposed mine planning device.

82. The method as claimed in claim 75, comprising receiving data indicative of audio, video and/or images from an external source and communicating the received data to a another remotely disposed mine planning device.
